(19) United States
(12) Patent Application Publication
(10) Pub. No.: US 2013/0002392 A1
(43) Pub. Date: Jan. 3, 2013

(54) MAGNETIC CORE

(75) Inventors: Rama Shankar Parashar, Staffordshire (GB); Jonathan Sturgess, Staffordshire (GB)

(73) Assignee: Alstrom Technology Ltd., Baden (CH)

(21) Appl. No.: 13/574,582

(22) PCT Filed: Jan. 27, 2010
(86) PCT No.: PCT/EP2010/050939

§ 371 Date: Sep. 14, 2012

(51) Int. Cl. H01F 27/24; H01F 41/02; B82Y 30/00

(52) U.S. Cl. 336/234; 156/182; 977/773

(57) ABSTRACT

A method of manufacturing a magnetic core includes joining first and second core stacks having a plurality of layers of magnetic core material arranged in a laminated structure so as to substantially align the magnetic core layers of the first core stack with those of the second core stack, and inserting a magnetic filler into gaps between the substantially aligned magnetic core layers so as to bridge the gaps between the substantially aligned magnetic core layers.

The invention relates to a method of manufacturing a magnetic core and, in particular, to a method of manufacturing a magnetic core for use in a transformer.

Transformers used in industrial and power transmission and distribution applications typically include primary and secondary windings wound around a magnetic core. Primary and secondary networks are connected to the primary and secondary windings.

In order to transfer electrical power from the primary network to the secondary network, an alternating current is passed through the primary winding. The alternating current in the primary winding produces an alternating magnetic flux in the magnetic core of the transformer, which in turn induces an alternating voltage in the secondary winding. The ratio of the number of turns in the primary winding to the number of turns in the secondary winding determines the ratio of the voltages across the two windings.

In other transformer arrangements, such as that of an autotransformer, the primary and secondary networks may be connected to a single winding wound around a magnetic core. In such an arrangement the networks are connected at different points, or taps, and a portion of the winding acts as part of both the primary and second winding.

In order to transfer electrical power from a source network, an electric current must flow through the primary winding connected to the source network to create a magnetic field in the magnetic core. This current is commonly referred to as the “magnetizing current” and is present even when power is not being delivered to the secondary network. The current flowing through the primary winding leads to resistive heating of both the primary winding and the power system connecting the primary winding to the power source, provided in the form of a power station or wind farm, and thereby results in power losses.

The magnetic core typically employed in a transformer generally has a higher permeability than the surrounding air. The magnetic field lines of the magnetic field created by the electric current flowing through the primary coil are therefore concentrated within the magnetic core structure. Using a magnetic core reduces power losses associated with the size of the magnetizing current required to establish the magnetic field because a lower magnetizing current is required to pass magnetic flux through a given length of magnetic material, which is more permeable than air, than through the corresponding length of air.

Transformers often include magnetic cores constructed using steel to constrain and guide the magnetic field, which has a higher permeability than air and therefore requires a lower magnetizing current per unit length than air. Steel is however an electrical conductor and eddy currents are therefore induced within steel cores when alternating magnetic flux passes through the cores, which results in power losses.

According to a first aspect of the invention there is provided a method of manufacturing a magnetic core comprising the steps of joining first and second stacks having a plurality of layers of magnetic core material arranged in a laminated structure so as to substantially align the magnetic core layers of the first core stack with those of the second core stack and inserting a magnetic filler into any gaps between the substantially aligned magnetic core layers so as to bridge the gaps between the substantially aligned magnetic core layers.

The use of first and second core stacks allows the manufacture of a magnetic core that is greater in size than a single core stack, and also allows the manufacture of magnetic cores having different shapes. For example, the core stacks may be arranged and joined to define a C-shaped, a U-shaped core, an H-I shaped core, an E-I shaped core, an L-shaped core or an I-shaped core.

The provision in each of the first and second core stacks of layers of magnetic core material helps to provide a magnetic core in which the power losses resulting from the creation of eddy currents in the magnetic core are reduced. The magnitude of any eddy currents induced in the magnetic core material when an alternating flux flows through the magnetic core material is greatly reduced by the relatively small cross-section of each layer of magnetic core material, which restricts the circulation of the eddy currents.

The relatively small cross-section of each magnetic layer also means the resultant magnetic core has a higher resistance than that of a non-laminated magnetic core.

The use of a magnetic filler to bridge any gaps between the substantially aligned magnetic core layers of the first and second core stacks facilitates, in use, the flow of magnetic flux from one core stack to the next while minimizing flux transfer between adjacent laminations and therefore the induction of eddy currents.

This is advantageous because unless very complex and expensive manufacturing processes are employed the abutting faces of the core stacks have an inevitable roughness. This means the abutting faces cannot be arranged in complete contact with one another and results in gaps between the substantially aligned magnetic layers than in the absence of the magnetic filler would result, in use, in the need for a greater magnetizing current.

The use of a magnetic filler therefore helps to reduce power losses that might otherwise arise from the existence of the gaps between the substantially aligned magnetic core layers of adjacent core stacks.

Preferably the method further includes the step of exciting the first and second core stacks to generate a magnetic field to attract the magnetic filler between the substantially aligned magnetic core layers.

This provides a simple technique for filling gaps that are small in cross-section, deep, variable in cross-section and/or otherwise difficult to access.

In embodiments of the invention the magnetic filler may include a fine powder of soft magnetic material, the soft magnetic material preferably including one or more elements chosen from the group of Fe, Co, Ni and ferritic steel and preferably being a ferromagnetic material.

The use of a fine powder allows the magnetic filler to accurately bridge any gaps between the substantially aligned magnetic core layers and prevents the creation of dead volume that might otherwise occur through the use of components that are comparable in size to any gaps. Any such dead volumes result in an irregular path for the flow of magnetic flux and may affect the magnetic properties of the magnetic core.

The excellent magnetic properties of soft magnetic materials, such as high saturation magnetization, low coercive force and high magnetic permeability, make such materials suitable for use as the magnetic filler and reduce the energy losses associated with magnetic hysteresis.

In other embodiments of the invention the magnetic filler may include a ferrofluid in which nano-sized particles of ferromagnetic material are suspended in a carrier fluid wherein each of the nano-sized particles preferably has a diameter in the range of 1-150 nm.

The use of a ferrofluid is advantageous in that it may be poured into any gaps between the substantially aligned magnetic core layers and will flow so as to occupy gaps of any shape and size.

The dispersion of the nano-sized particles in the carrier fluid ensures a substantially uniform distribution of magnetic properties throughout the carrier fluid.

The ferromagnetic material may include one of, or a combination of, a ferromagnetic element, a ferromagnetic oxide and a ferromagnetic alloy, and may be provided in an amorphous state, a super paramagnetic state, a regular alloyed ferromagnetic state or a crystalline state.

In such embodiments, the ferromagnetic material may include a ferromagnetic alloy chosen from the group of Fe—Ni, Fe—Co, Fe—Ag, Co—Pt and Fe—Pt.

In other such embodiments, the ferromagnetic material may include a ferromagnetic oxide chosen from the group of alpha Fe₂O₃, gamma-Fe₂O₃, FeO and Fe₃O₄.

In yet further such embodiments, the ferromagnetic material may include a ferromagnetic oxide alloyed with one or more electrically conductive elements chosen from the group of Ni, Co, Pd, Ag, Au and Pt.

Preferably each of the nano-sized particles is coated in an electrically conductive element chosen from the group of Ni, Co, Pd, Ag, Au and Pt.

Coating the nano-sized particles in an electrical conductive element provides a means of modifying the magnetic properties of the nano-sized particles and therefore the magnetic filler.

In other embodiments, the magnetic filler may include a magneto-rheological material, which undergoes a viscosity change on the application of an electric field.

In such embodiments the magneto-rheological material may be combined with a fine powder of soft magnetic material and/or a ferrofluid in which nano-sized particles of ferromagnetic material are suspended in a carrier fluid and/or an amorphous magnetic material such as, for example, Metglas®.

Such flexibility and variety in the composition of the magnetic filler allows the custom creation of a magnetic filler with properties matching the properties of a selected magnetic core. Otherwise a standard magnetic filler with standard properties is only suitable for a limited number of magnetic cores and thereby limits the number of possible magnetic core-based application.

In order to ensure the magnetic filler is retained in position within any gaps between the substantially aligned magnetic core layers, the magnetic filler may be mixed with an uncured and flowable polymer base material. In embodiments of the invention, the uncured and flowable polymer base material may be an epoxy system. The use of an uncured and flowable polymer base material allows the magnetic filler to be injected or otherwise inserted into any gaps. The method then preferably further includes the step of curing the uncured polymer base material.

Curing of the uncured polymer base, which may be achieved by heating the core stacks, causes the uncured polymer base to solidify and retain the magnetic filler in position within the gaps between the substantially aligned magnetic core layers.

Whatever form of magnetic filler used, the method preferably further includes the step of sealing the core stacks. Sealing the core stacks, either by providing a sealant material to envelope the core stacks or by inserting one of more seals into apertures within the core stacks prevents leakage of the magnetic filler material from any gaps between the substantially aligned magnetic core layers of the core stacks.

According to a second aspect of the invention there is provided a magnetic core comprising first and second core stacks, each core stack including a plurality of layers of magnetic core material arranged in a laminated structure, the core stacks being joined together such that the magnetic core layers of the first core stack are substantially aligned with those of the second core stack and a magnetic filler is provided to bridge any gaps between the substantially aligned magnetic core layers.

Preferred embodiments of the invention will now be described, by way of non-limiting examples, with reference to the accompanying drawings in which:

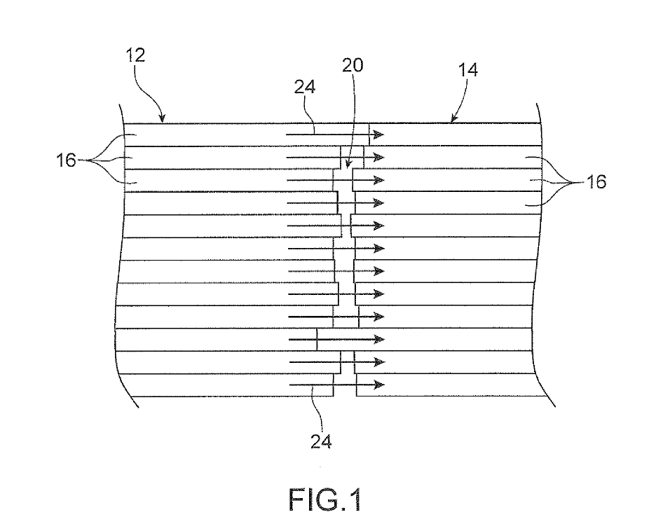

FIG. 1 shows the flux distribution in a magnetic core in which two laminated core stacks are joined using a butt joint;

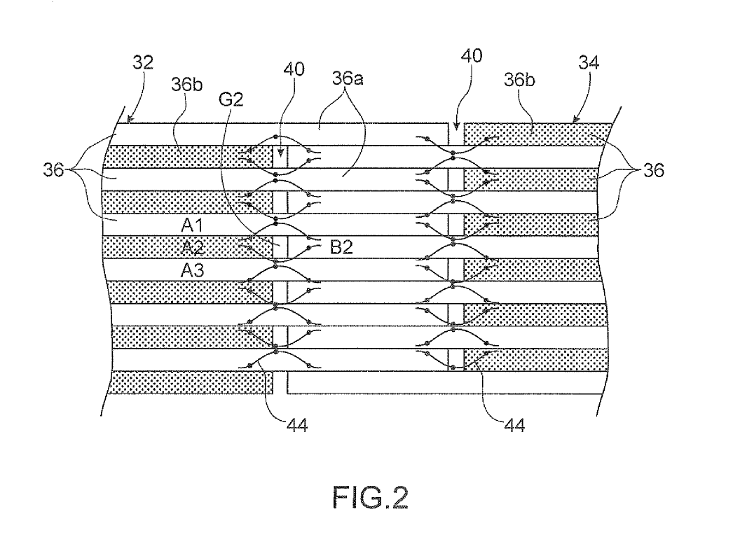

FIG. 2 shows the flux distribution in a magnetic core in which two laminated core stacks are joined using a lap joint;

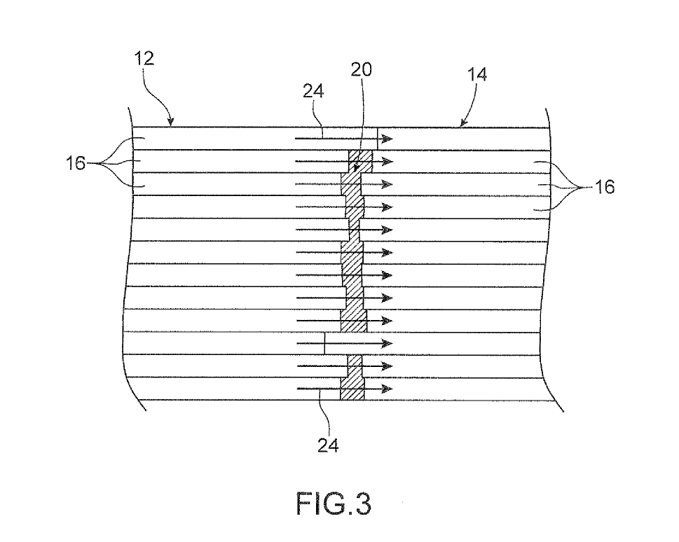

FIG. 3 shows the flux distribution in a magnetic core in which two laminated core stacks are joined using a butt joint and magnetic filler is used to bridge the gaps between substantially aligned and separated magnetic core layers; and

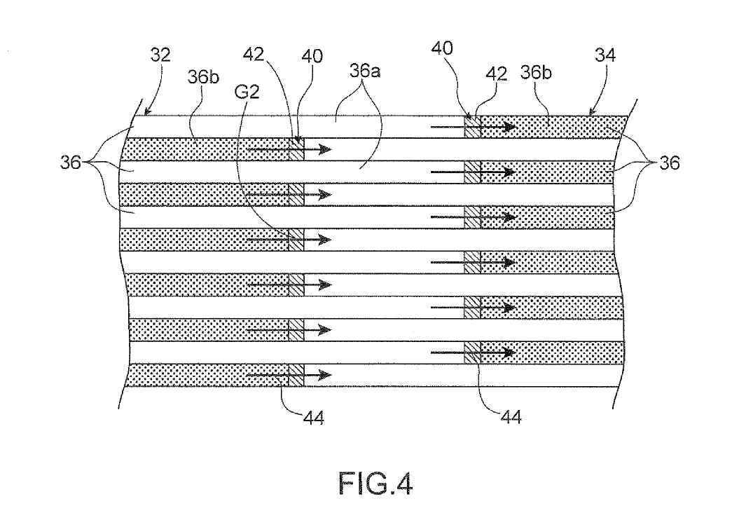

FIG. 4 shows the flux distribution in a magnetic core in which two laminated core stacks are joined using a lap joint and magnetic filler is used to bridge the gaps between substantially aligned and separated magnetic core layers.

A method of manufacturing a magnetic core 10 according to an embodiment of the invention will be described with reference to FIGS. 1 and 3.

The method involves the step of joining first and second core stacks 12,14 using a butt joint. It is envisaged that the butt joint may be a 90° T joint or a mitred joint. The first and second core stacks 12,14 may be joined to form a C-shaped magnetic core, a U-shaped magnetic core, an H-I shaped magnetic core, an E-I shaped magnetic core, an L-shaped magnetic core or an I-shaped core.

Each of the core stacks 12,14 includes a plurality of layers of magnetic core material 16 arranged in a laminated structure and the core stacks 12,14 are arranged relative to each other so as to substantially align the magnetic core layers 16 of the first core stack 12 with those of the second core stack 14, as shown in FIG. 1.

The magnetic core layers 16 may be made from iron, steel or other magnetic material depending on the desired magnetic properties of the resultant magnetic core 10.

The edges of the core stacks 12,14 are butted together so as to minimize any gaps 20 between the substantially aligned magnetic core layers 16. A magnetic filler 22 is then inserted into the gaps 20 so as to bridge the gaps 20 between the substantially aligned magnetic core layers 16, as shown in FIG. 3.

The magnetic filler 22 is provided in the form of a ferrofluid in which nano-sized particles of ferromagnetic material are suspended in a carrier fluid.

The use of a ferrofluid is advantageous in that the carrier fluid is able to flow into the gaps 20 between the substantially aligned magnetic core layers 16 and thereby carry the nano-sized particles of ferromagnetic material suspended in the carrier fluid into the gaps 20.

During insertion of the magnetic filler 22 the first and second core stacks 12,14 are preferably excited to generate a magnetic field to attract the magnetic filler 22 into the gaps 20 between the substantially aligned magnetic core layers 16.

Prior to removal of the magnetic field, the first and second core stacks 12,14 are sealed to prevent leakage of the magnetic filler 22 from the gaps 20 following removal of the magnetic field.

Each of the nano-sized particles of ferromagnetic material preferably has a diameter in the range of 1-150 nm.

The ferromagnetic material may include one of, or a combination of, a ferromagnetic element, a ferromagnetic oxide and a ferromagnetic alloy, and may be provided in an amorphous state, a super paramagnetic state, a regular alloyed ferromagnetic state or a crystalline state.

Examples of suitable ferromagnetic alloys include, but are not limited to, Fe—Ni, Fe—Co, Fe—Pd, Fe—Ag, Fe—Au, Co—Pt and Fe—Pt. Other ferromagnetic alloys may include a ferromagnetic oxide alloyed with one or more electrically conductive elements.

Examples of suitable ferromagnetic oxides include, but are not limited to, alpha-Fe₂O₃, gamma-Fe₂O₃, FeO and Fe₃O₄.

The nano-sized particles may be coated in one or more electrically conductive elements to impart desired magnetic properties to the nano-sized particles.

Examples of electrically conductive elements for the purposes of alloying or coating include, but are not limited to, Ni, Co, Pd, Ag, Au and Pt.

Such flexibility and variety in the composition of the magnetic filler 22 allows the creation of a magnetic filler 22 with very specific properties so as to match the properties of the magnetic core layers 16.

The resultant magnetic core 10 is shown in FIG. 3 and includes the first and second core stacks 12,14 joined together using a butt joint in which a face of the first core stack 12 abuts a face of the second core stack 14.

The core stacks 12,14 are joined such that the magnetic core layers 16 of the first core stack 12 are substantially aligned with the magnetic core layers 16 of the second core stack 14. The magnetic filler 22 bridges the gaps 20 between the substantially aligned magnetic core layers 16.

The use of layers of magnetic core material 16 reduces the power losses associated, in use, with induced eddy currents in the magnetic core as a result of changes in a magnetic field induced in the magnetic core 10, as will be outlined below.

Each of the magnetic core layers 16 of the first core stack 12 is either in abutment with or separated by a gap 20 from the corresponding magnetic core layer 16 of the second core stack 14. The gaps 20 are variable in length because some magnetic core layers 16 may project over others and the level of projection may vary between different magnetic core layers 16.

The disparity in magnetic core layer projection is due to a variation in dimensions between magnetic core layers 16 arising from manufacturing limitations such as dimensional tolerance. As a result the dimensions of each magnetic core layer 16 may vary within a specified dimensional tolerance. The variation in dimensions between magnetic core layers 16 may also be caused by manufacturing faults, for example, during a layer cutting/stamping process or a lamination process.

The magnetic core 10 includes a magnetic filler 22 bridging the gaps 20 between the substantially aligned magnetic core layers.

In use, each magnetic core layer 16 receives a portion of the magnetic flux 24 flowing in the magnetic core 10. Variations in a magnetic field within a magnetic core material leads to the creation of eddy currents within the magnetic core material and eddy currents are created in the magnetic core layers 16, in use, as a result of variations in the magnetic flux 24 flowing in the magnetic core 10. The relatively small cross-section of each magnetic core layer 16 however restricts the circulation of any such eddy currents. In addition, the relatively small cross-section of each magnetic core layer 16 also means that each of the first and second core stacks 12,14 has a higher resistance than a non-laminated core stack.

The laminated structure of each of the first and second core stacks 12,14 therefore leads to a reduction in power losses that might otherwise arise during use from eddy currents created as a result of changes in the magnetic field applied to the magnetic core 10.

The magnetic filler 22 filing the gaps 20 defines a continuous path for the magnetic flux 24 flowing between the substantially aligned magnetic core layers 16.

The provision of a continuous path between the substantially aligned magnetic core layers 16 reduces the magnetizing current required to create the magnetic field in the magnetic core 10 than would be the case in the absence of the magnetic filler 22, as shown in FIG. 1. The existence of gaps 20 filled with air would require a greater magnetizing current to create the magnetic field in the magnetic core 10 as a result of the lower permeability of air compared with the magnetic filler 22.

A method of manufacturing a magnetic core 30 according to a second embodiment of the invention will now be described with reference to FIGS. 2 and 4.

The method again involves the step of joining first and second core stacks 32,34, each of the first and second core stacks 32,34 including a plurality of layers of magnetic material 36 arranged in a laminated structure. The first and second core stacks 32,34 are joined using lap joints such that layers of magnetic core material 36 from each core stack 32,34 overlap each other.

More specifically each of the first and second core stacks 32,34 includes alternate primary and secondary layers 36a,36b. The primary layers 36a of each of the first and second core stacks 32,34 are interlocked so that each primary layer 36a is substantially aligned with a corresponding secondary layer 36b of the other core stack 32,34, as shown in FIG. 2.

While each of the primary and secondary layers 36a,36b is shown in FIG. 2 as a single layer, it is envisaged that each of these layers 36a,36b may comprise a plurality of laminated sub-layers.

The magnetic core layers 36 may be made from iron, steel or other magnetic material depending on the desired magnetic properties of the resultant magnetic core 30.

The first and second core stacks 32,34 are arranged so as to minimize any gaps 40 between the substantially aligned primary and secondary layers 36a,36b. A magnetic filler 42 is then inserted into the gaps 40 so as to bridge the gaps 40 between the substantially aligned primary and secondary layers 36a,36b, as shown in FIG. 4.

The magnetic filler 42 is provided in the form of a fine powder of soft magnetic material mixed with an uncured and flowable polymer base material such as, for example, an epoxy system.

The use of a fine powder of soft magnetic material is advantageous in that it allows the magnetic filler 42 to accurately bridge the gaps 40 between the substantially aligned primary and secondary layers 36a,36b. In addition, mixing the magnetic filler 42 with an uncured and flowable polymer base material means that the polymer base material is able to flow into the gaps 40 and thereby carry the magnetic filler 42 into the gaps 40.

During insertion of the magnetic filler 42, the first and second core stacks 32,34 are preferably excited to generate a magnetic field to attract and draw the magnetic filler 42 into the gaps 40.

Prior to removal of the magnetic field, the uncured and flowable polymer base material is cured, preferably by heating. Curing the polymer base material causes it to solidify and thereby seal the magnetic filler 42 in position within the gaps 40 following removal of the magnetic field.

The soft magnetic material is chosen so as share substantially the same magnetic properties as the resultant magnetic core 30.

The use of a soft magnetic material is advantageous in that such materials do not permanently retain their magnetization after an external field is removed. In use, this reduces power losses that may otherwise be associated with magnetic hysteresis.

As well as having low magnetic hysteresis, soft magnetic materials also have high magnetic saturation, low coercive force and high magnetic permeability. The high magnetic permeability is particularly advantageous in that it lowers the amount of energy required to pass magnetic flux through the material.

Preferably the soft magnetic material is a material based on Fe, Co or Ni which has been rapidly quenched from its molten state to freeze its amorphous structure. An example of a suitable soft magnetic material is Metglas®.

The resultant magnetic core 30 is shown in FIG. 4 and includes first and second core stacks 32,34 joined together using lap joints in which a face of each of the primary layers 36a of the first core stack 32 abuts a face of a corresponding secondary layer 36b of the second core stack 34, and vice versa. The magnetic filler 42 bridges the gaps 40 between the substantially aligned primary and secondary layers 36a,36b.

In use, each of the primary and secondary layers 36a,36b of the first and second core stacks 32,34 receives a portion of the magnetic flux 44 flowing in the magnetic core 40. As with the magnetic core 10 shown in FIG. 3, the relatively small cross-section of each of the primary and secondary layers 36a,36b restricts the circulation of any eddy currents created as a result of variations in the magnetic flux 44 flowing in the magnetic core 30. In addition, the relatively small cross-section of each of the primary and secondary layers 36a,36b also means that each of the first and second core stacks 32,34 has a higher resistance than a non-laminated core stack.

The laminated structure of each of the first and second core stacks 32,34 therefore leads to a reduction in power losses that might otherwise arise during use from eddy currents created as a result of changes in the magnetic field applied to the magnetic core 30.

The magnetic filler 42 filing the gaps 40 defines a continuous path for the magnetic flux 44 flowing between the substantially aligned primary and secondary layers 36a,36b.

The provision of a continuous path between the substantially aligned primary and secondary layers 36a,36b reduces the magnetizing current required to create the magnetic field in the magnetic core 30 than would be the case in the absence of the magnetic filler 42, as shown in FIG. 2.

In the absence of the filler material 42, the magnetic flux 44 will by-pass the gaps 40 by crossing into the adjacent magnetic core layers 36, as illustrated by arrows A in FIG. 2. For example, referring to FIG. 2, magnetic flux 44 on reaching gap G2 between substantially aligned layers A2 and B2 will transfer into layers A1 and A3 to bypass gap G2 before transferring back into layer B2. This is because less energy is required to make magnetic flux 44 flow in highly-permeable magnetic materials A1 and A3 than it does to make it flow in air G2.

However, the transfer of magnetic flux 44 between the magnetic core layers 36 results in a change in flux perpendicular to the plane of the layer, which induces eddy currents in the magnetic core layers 36. This in turn contributes to power losses and affects the efficiency of the magnetic core 30.

The existence of gaps 40 filled with air would require a greater magnetizing current to create the magnetic field in the magnetic core 10 as a result of the lower permeability of air compared with the magnetic filler 22.

In the magnetic core 30 shown in FIG. 4 however the magnetic filler 42 fills the gaps 40 and thereby defines a continuous path for the magnetic flux 44 flowing between the substantially aligned primary and secondary layers 36a,36b.

The provision of a continuous path between the substantially aligned primary and secondary layers 36a,36b reduces the magnetizing current required to create the magnetic field in the magnetic core 30 than would be the case in the absence of the magnetic filler 42, as shown in FIG. 2. It also reduces the tendency for magnetic flux 44 to transfer between the magnetic core layers 36, and thereby reduces the loss due to eddy currents in the core.

In other embodiments, the method of manufacturing the magnetic core may involve additional core stacks to construct magnetic core structures of varying shapes and sizes. It is also envisaged that butt joints, lap joints, T-joints, step joints or a combination of any such joints may be used to joint the core stacks.

It is also envisaged that in other embodiments the magnetic filler may include a magneto-rheological material.

It is also envisaged that in yet further embodiments particles of amorphous magnetic materials, such as for example Metglas®, ferrofluid containing nano-sized particles of a ferromagnetic material and magneto-rheological materials may be mixed in different combinations with an uncured and flowable polymer base.

1. A method of manufacturing a magnetic core comprising the steps of joining first and second core stacks having a plurality of layers of magnetic core material arranged in a laminated structure so as to substantially align the magnetic core layers of the first core stack with those of the second core stack and inserting a magnetic filler into any gaps between the substantially aligned magnetic core layers so as to bridge the gaps between the substantially aligned magnetic core layers.

2. A method of manufacturing a magnetic core according to claim 1 further including the step of exciting the first and second core stacks to generate a magnetic field to attract the magnetic filler into any gaps between the substantially aligned magnetic core layers.

3. A method of manufacturing a magnetic core according to claim 1 or claim 2 wherein the magnetic filler includes a fine powder of soft magnetic material.

4. A method of manufacturing a magnetic core according to claim 3 wherein the soft magnetic material includes one or more elements chosen from the group of Fe, Co, Ni and ferritic steel.

5. A method of manufacturing a magnetic core according to claim 3 or claim 4 wherein the soft magnetic material is a ferromagnetic material.

6. A method of manufacturing a magnetic core according to claim 1 or claim 2 wherein the magnetic filler includes a ferrofluid in which nano-sized particles of ferromagnetic material are suspended in a carrier fluid.

7. A method of manufacturing a magnetic core according to claim 6 wherein each of the nano-sized particles has a diameter in the range of 1-150 nm.

8. A method of manufacturing a magnetic core according to any of claims 5 to 7 wherein the ferromagnetic material includes one of, or a combination of, a ferromagnetic element, a ferromagnetic oxide and a ferromagnetic alloy, and is provided in an amorphous state, a super paramagnetic state, a regular alloyed ferromagnetic state or a crystalline state.

9. A method of manufacturing a magnetic core according to claim 8 wherein the ferromagnetic material includes a ferromagnetic alloy chosen from the group of Fe—Ni, Fe—Co, Fe—Pd, Fe—Ag, Fe—Au, Co—Pt and Fe—Pt.

10. A method of manufacturing a magnetic core according to claim 8 wherein the ferromagnetic material includes a ferromagnetic oxide chosen from the group of alpha-Fe₂O₃, gamma-Fe₂O₃, FeO and Fe₃O₄.

11. A method of manufacturing a magnetic core according to claim 8 or claim 10 wherein the ferromagnetic material includes a ferromagnetic oxide alloyed with one or more electrically conductive elements chosen from the group of Ni, Co, Pd, Ag, Au and Pt.

12. A method of manufacturing a magnetic core according to claim 6 and any claim dependent thereon wherein each of the nano-sized particles is coated in one or more electrically conductive elements chosen from the group of Ni, Co, Pd, Ag, Au and Pt.

13. A method of manufacturing a magnetic core according to any preceding claim wherein the magnetic filler includes a magneto-rheological material.

14. A method of manufacturing a magnetic core according to any preceding claim wherein the magnetic filler is mixed with an uncured and flowable polymer base material.

15. A method of manufacturing a magnetic core according to claim 14 wherein the uncured and flowable polymer base material is an epoxy system.

16. A method of manufacturing a magnetic core according to claim 14 or claim 15 further including the step of curing the uncured polymer base material following insertion of the magnetic filler into any gaps between the substantially aligned magnetic core layers.

17. A method of manufacturing a magnetic core according to any preceding claim further including the step of sealing the first and second core stacks following insertion of the magnetic filler into any gaps between the substantially aligned magnetic core layers.

18. A magnetic core manufactured in accordance with the method claimed in any of the preceding claims.

19. A magnetic core comprising first and second core stacks, each core stack including a plurality of alternating layers of magnetic core material arranged in a laminated structure, the core stacks being joined together such that the magnetic core layers of the first core stack are substantially aligned with those of the second core stack and a magnetic filler is provided to bridge any gaps between the substantially aligned magnetic core layers.

20. A magnetic core according to claim 19 wherein the magnetic filler includes a fine powder of soft magnetic material.

21. A magnetic core according to claim 20 wherein the soft magnetic material includes one or more elements chosen from the group of Fe, Co, Ni and ferritic steel.

22. A magnetic core according to claim 20 or claim 21 wherein the soft magnetic material is a ferromagnetic material.

23. A magnetic core according to claim 19 wherein the magnetic filler includes a ferrofluid in which nano-sized particles of ferromagnetic material are suspended in a carrier fluid.

24. A magnetic core according to claim 23 wherein each of the nano-sized particles has a diameter in the range of 1-150 nm.

25. A magnetic core according to any of claims 22 to 24 wherein the ferromagnetic material includes one of, or a combination of, a ferromagnetic element, a ferromagnetic oxide and a ferromagnetic alloy, and is provided in an amorphous state, a super paramagnetic state, a regular alloyed ferromagnetic state or a crystalline state.

26. A magnetic core according to claim 25 wherein the ferromagnetic material includes a ferromagnetic alloy chosen from the group of Fe—Ni, Fe—Co, Fe—Pd, Fe—Ag, Fe—Au, Co—Pt and Fe—Pt.

27. A magnetic core according to claim 25 wherein the ferromagnetic material includes a ferromagnetic oxide chosen from the group of alpha-Fe₂O₃, gamma-Fe₂O₃, FeO and Fe₃O₄.

28. A magnetic core according to claim 25 or claim 27 wherein the ferromagnetic material includes a ferromagnetic oxide alloyed with one or more electrically conductive elements chosen from the group of Ni, Co, Pd, Ag, Au and Pt.

29. A magnetic core according to claim 23 and any claim dependent thereon wherein each of the nano-sized particles is coated in one or more electrically conductive elements chosen from the group of Ni, Co, Pd, Ag, Au and Pt.

30. A magnetic core according to any of claims 19 to 29 wherein the magnetic filler includes a magneto-rheological material.

31. A magnetic core according to any of claims 19 to 30 wherein the magnetic filler is mixed with and held within a cured polymer base material.

32. A magnetic core according to any of claims 19 to 31 wherein the first and second core stacks are sealed.
